(19) United States
(12) Patent Application Publication
(10) Pub. No.: US 2019/0025189 A1
(43) Pub. Date: Jan. 24, 2019

(54) CORROSION TESTING SYSTEM FOR MULTIPHASE ENVIRONMENTS USING ELECTROCHEMICAL AND WEIGHT-LOSS METHODS

(71) Applicant: Saudi Arabian Oil Company, Dhahran (SA)

(72) Inventors: Yahya T. Al-Janabi, Dhahran (SA); Turki A. Al-Khaldi, Dammam (SA)

(21) Appl. No.: 15/656,728

(22) Filed: Jul. 21, 2017

(51) Int. Cl. G01N 17/02; G01N 17/04

(52) U.S. Cl. CPC G01N 17/02; G01N 17/046

(57) ABSTRACT

A system for conducting measuring corrosion rates in a multiphase environment using electrochemical and weight-loss measurement methods on test coupons is provided. A plurality of inserts is disposed within a test vessel in a vertical arrangement. Each insert is provided with at least one test coupon and at least one working electrode that are exposed to the corrosive test environment within vessel. A test fluid mixture is added to the vessel and the temperature and pressure is maintained such that the mixture exists in a multiphase condition that has a vertical stratification such that each insert is exposed to a different phase of the fluid. Electrical signals from the working electrode is measured to determine the corrosion rate using an electrochemical method. The pre-test weight of the coupon is compared to the post-test weight to determine the corrosion rate using a weight-loss method.

### FIELD OF THE INVENTION

This patent application generally relates to corrosion testing, and more particularly to systems for multiphase, multimethod testing.

### BACKGROUND OF THE INVENTION

Performing corrosion measurements is often a time consuming process since it requires exposing test samples to a corrosive environment for an extended duration of time and then measuring the amount of corrosion of the test sample. Typically, one environmental condition is tested during each test process. Accordingly, if varying environments are to be evaluated, several separate corrosion tests must be performed. Moreover, test systems either rely upon measuring weight loss of the test samples during the test or, upon measuring electrical signals in the corrosive environment. However, typically these types of tests require different experimental setups and that further increase the number of tests required, which further increases time and costs.

The present invention provides a solution to these and other problems.

### SUMMARY OF THE INVENTION

In one aspect of the invention, a multi-phase testing system for testing corrosive environments by providing a test fluid mixture that is at a different phase at different locations within the system in surrounding relation to a plurality of test coupons is provided. The corrosion rates can be determined via weight-loss means and electrochemical means on the plurality of test coupons. The testing system includes a housing defining an inner chamber a plurality of inserts disposed vertically within the housing. Each insert defines an interior area and an interior surface. At least one test coupon among the plurality of test coupons is disposed at an inner surface of each of the plurality of inserts. A plurality of electrical probes is provided. At least one electrical probe is disposed at an inner surface of each of the plurality of inserts, and each electrical probe has an electrical lead wire electrically connected to the electrical probe and extending outside the housing for reading electrical signals through the wire. A plurality of separator plates, wherein one of the plurality of separator plates is disposed between each adjacent insert. The separator plates are configured to maintain a separation between each of the phases of the multi-phase test fluid disposed within the housing so that each of the test coupons and electrical probes in each of the inserts is exposed to a different phase of the test fluid. Corrosion is measured by measuring the amount of weight-loss of each of the test coupons and by measuring the electrical signals from each electrical probe.

According to a further aspect, each insert includes a plurality of grooves disposed about the inner surface of the inserts, wherein the grooves are sized and shaped to receive test coupons and electrical probes, respectively.

According to a still further aspect, which can be combined in an embodiment constructed in accordance with one or more of the foregoing aspects, the grooves have a dovetail shape.

According to a further aspect, which can be combined in an embodiment constructed in accordance with one or more of the foregoing aspects, each insert includes at least one window that permits viewing of the interior area of the insert.

According to another aspect, which can be combined in an embodiment constructed in accordance with one or more of the foregoing aspects, a reference electrode and a counter electrode are disposed within the housing that provide a reference electrical signal and a counter electrode electrical signal that are capable of being used, in combination with the electrical signal from the electrical probes, to measure corrosion using electrical signals.

According to a still further aspect, which can be combined in an embodiment constructed in accordance with one or more of the foregoing aspects, the system further includes a stirring rod for stirring the test fluid disposed within the housing.

According to a further aspect, which can be combined in an embodiment constructed in accordance with one or more of the foregoing aspects, the system further includes a plurality of baffles supported by the inserts.

According to another aspect, a method for performing multi-phase testing of corrosive environments via a weight-loss method and an electrochemical method by providing a test fluid mixture that is at a different phase at different locations within the system is provided. The method includes the step of providing a test system. The test system includes a housing defining an inner chamber and a plurality of inserts disposed vertically within the housing, each insert defining an interior area and an interior surface. A plurality of test coupons is provided and at least one test coupon is disposed at an inner surface of each of the plurality of inserts. A plurality of electrical probes, wherein at least one electrical probe is disposed at an inner surface of each of the plurality of inserts, are provided. Each electrical probe has an electrical lead wire electrically connect to the electrical probe and extending outside the housing for reading electrical signals through the wire. A plurality of separator plates, wherein one of the plurality of separator plates is disposed between each adjacent insert, is provided. The separator plates are configured to maintain a separation between each of the phases of the multi-phase test fluid disposed within the housing so that each of the test coupons and electrical probes in each of the inserts is exposed to a different phase of the test fluid. The method includes the step of providing the test fluid in the inner chamber of the housing. The temperature and pressure are maintained within the housing such that the test fluid exists as a vertically stratified, multiphase fluid. An electrochemical corrosion rate is determined by measuring the electrical signals from the electrical probes. A weight-loss corrosion rate is determined by comparing a pre-test and a post-test weight of the coupons. The determined corrosion rates from the test coupons and electrical probes from each respective, vertically arranged insert corresponds to the corrosion rate for a corresponding, respective phase of the vertically stratified, multiphase fluid.

### BRIEF DESCRIPTION OF THE DRAWINGS

The accompanying drawing figures illustrate exemplary embodiments and are not intended to be limiting of the invention. Among the drawing figures, like references are intended to refer to like or corresponding parts.

FIG. 1 illustrates a schematic side view of the multiphase testing system according to an embodiment of the invention;

FIG. 2 illustrates a top view of an insert thereof;

FIG. 3 illustrates a side view of an insert thereof;

FIG. 4 illustrates a top view of a separator disc thereof;

FIG. 5 illustrates an electrical probe thereof; and

FIG. 6 illustrates a coupon thereof.

### DETAILED DESCRIPTION OF CERTAIN EMBODIMENTS OF THE INVENTION

The invention is now described with reference to the accompanying drawings, which form a part hereof, and which show, by way of illustration, example implementations and/or embodiments of the present invention. It is to be understood that other embodiments can be implemented and structural changes can be made without departing from the spirit of the present invention. Among other things, for example, the disclosed subject matter can be embodied as methods, devices, components, or systems.

Furthermore, it is recognized that terms may have nuanced meanings that are suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter can be based upon combinations of individual example embodiments, or combinations of parts of individual example embodiments.

In accordance with the present application, embodiments are provided that are directed to systems and devices for providing high throughput screening and evaluation of materials and corrosion inhibitors under dynamic multiphase sour environments. In certain embodiments, each reactor includes three identical inserts. Each insert is a stationary cage system for performing corrosion evaluations. The inserts are arranged vertically in the reactor to study three environmental phases: aqueous, aqueous/hydrocarbon interface, and gas, which are vertically stratified within the reactor chamber. Moreover, the present system permits for measuring corrosion using both electrochemical and weight-loss methods. Accordingly, multiple samples can be evaluated under different environmental conditions within the same reactor vessel at the same time, which provides for an efficient, fast, and economical system for testing a variety of sample under a variety of conditions.

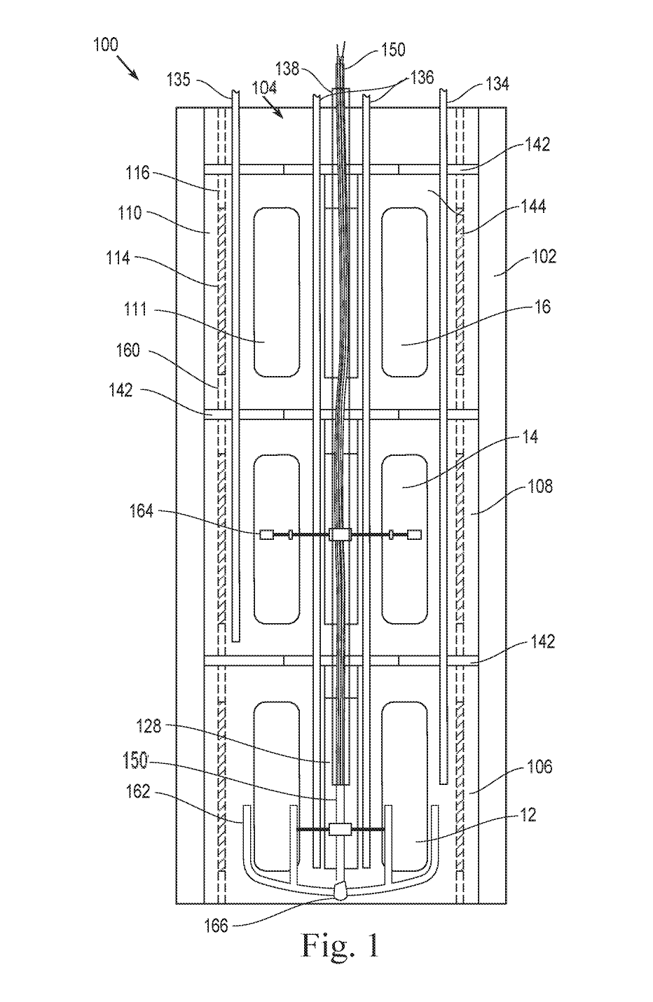

According to one aspect, as shown in FIG. 1, the environmental test tool 100 is shown. The test tool 100 includes an outer vessel 102. The outer vessel 102 provides the outer containment structure for the test tool 100. The outer vessel 102 provides an interior space 104 into which the cage assemblies, test coupons, and environmental test medium can be contained. The outer vessel 102 can be generally cylindrical in shape and is designed to withstand a variety of temperatures and pressures that are generated during testing procedures. The outer vessel 102 can be made from corrosion resistant materials such as glass or suitable metallic alloys (e.g., Hastelloy C276), for example.

As shown in FIG. 1, three test coupon/probe holder inserts are disposed within the interior space 104 of the outer vessel 102 and are surrounded by the test fluid during testing. A lower insert 106 is disposed at a bottom end of outer vessel 102, a middle insert 108 is disposed at a mid-region of the outer vessel, and an upper insert 110 is disposed at an upper end of the outer vessel. As discussed above, in one embodiment the three test coupon/probe holder inserts 106, 108, and 110 are substantially similar in construction so that differences in the corrosion rates of the coupons are a result of differences in the exposures environment (aqueous, aqueous/hydrocarbon interface, and gas) rather than as a result of differences in the coupon holders themselves. In other embodiments, the holder inserts can be made of different constructions, when the coupons warrant that arrangement, with any differences in the various coupon holders accounted for in the evaluation of the experimental data.

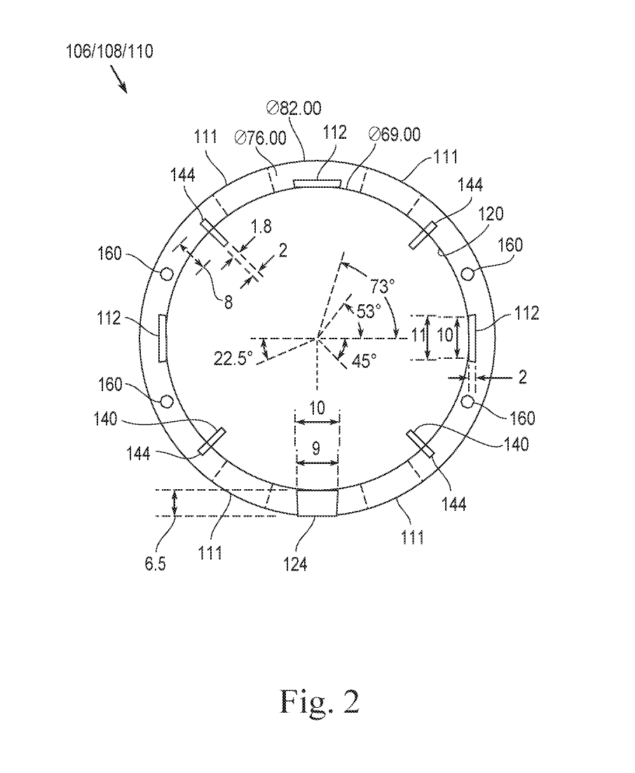

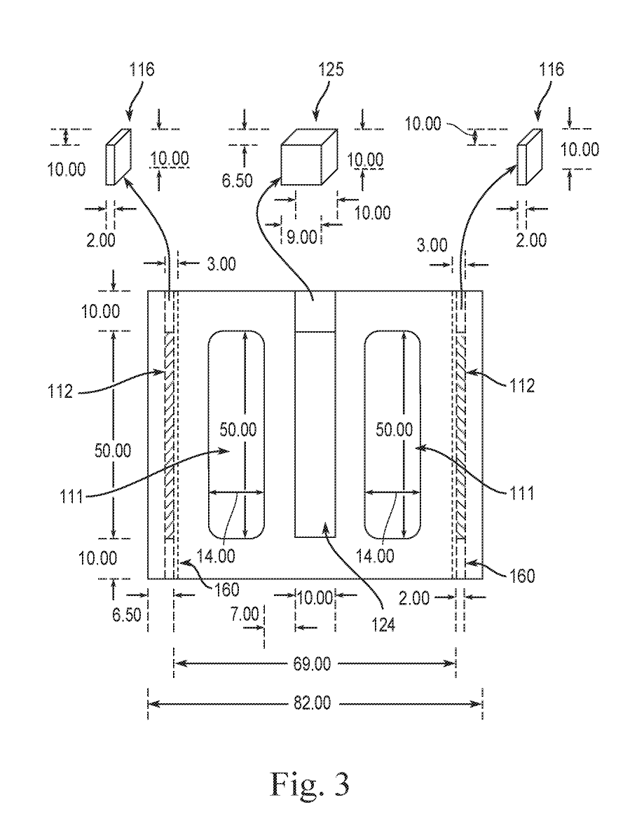

Referring to FIGS. 2 and 3, the test coupon/probe holder inserts 106, 108, and 110 are described in more detail. The inserts 106, 108, and 110 have a generally cylindrical tubular shape and are sized and shaped to be disposed within the outer vessel 102. The outer diameter of the inserts 106, 108, and 110 can be sized so that it just fits within the interior of the outer vessel 102 with minimal gap. As one example, if the inner diameter of the outer vessel 102 is 84 mm, the outer diameter of the inserts 106, 108, and 110 can be 82 mm, and further having an inner diameter of 69 mm and a height of 70 mm. The inserts can be made from a corrosion resistant material. One suitable corrosion resistant material is a PEEK tube, which is a high temperature thermoplastic that is resistant to chemical and fatigue environments. The PEEK tube material can further include glass fibers (i.e., glass filled) that further increase the strength and performance characteristics of the PEEK tube. The inserts can include windows 111 that permit visual inspection of an interior of the inserts and the test samples supported therein. The outer vessel 102 can be made of glass so that visual inspection can occur during testing.

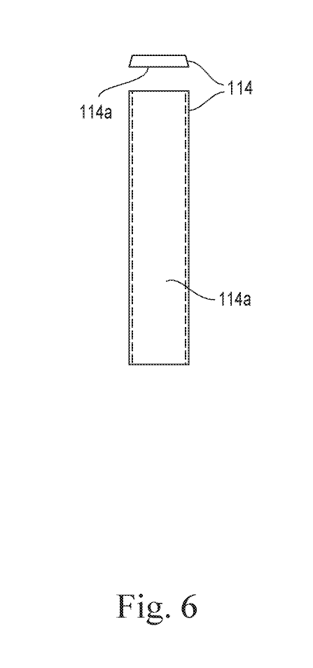

The inserts 106, 108, and 110 include a plurality of grooves 112. The grooves can have a dovetail shape. In one embodiment, the dovetail can be sized and shaped to receive and hold correspondingly shaped coupons 114 of material to be tested, as can be seen in FIGS. 2 and 6. The dovetail shape of the grooves, when provided, allows for vertical insertion and removal of the coupons from the grooves while preventing lateral movement within the grooves to retain the coupons within the inserts in position for testing. Holding blocks 116 can be inserted into the grooves 112 above and below each coupon 114 to hold the coupons vertically in position within the grooves. As an example, the holding blocks 116 can be made of the same material as the inserts (e.g., PEEK). According, when the coupons 114 are positioned within the grooves the outer face 114a of the coupons are substantially flush with the inner wall of the 120 of the inserts so that the outer face 114a of the coupons are exposed to the test environment with reduced turbulent current effects within the test fluid that could otherwise improperly impact the results of the testing. With the outer face 114a of the coupons exposed, testing can be evaluated while the other surfaces of the coupons are within the material of the inserts. As shown in FIG. 2, each insert can include three coupon grooves 112 disposed about their perimeters. These coupons 114 can be used for measuring corrosion via a weight loss method. In the weight loss method, the weight of the coupons are measured before and after exposure to the test environment and the corrosion rates can be calculated taking into account the test duration (i.e., time of exposure).

An additional electrical probe 122 can be provided at each insert 106, 108, and 110 and can be used to measure corrosion using electrical methods, as discussed in more detail below. As shown in FIGS. 2 and 3, each insert 106, 108, and 110 can include an additional groove 124 to accommodate an electrical probe 122, which is the working electrode in the electrical measurement system that is discussed in more detail below. In one embodiment, the groove 124 is dovetail-shaped and can be sized and shaped to be close fitting with the electrical probe 122. For example, the groove 124 can be 50 mm×10 mm×7 mm and the electrical probe 122 can be 50 mm×10 mm×6.5 mm, which provides for a close fit of the electrical probe within the groove 124. Positioning blocks 125 can be inserted into each of the grooves 124 in a respective insert to maintain the electrical probes 122 in their respective grooves.

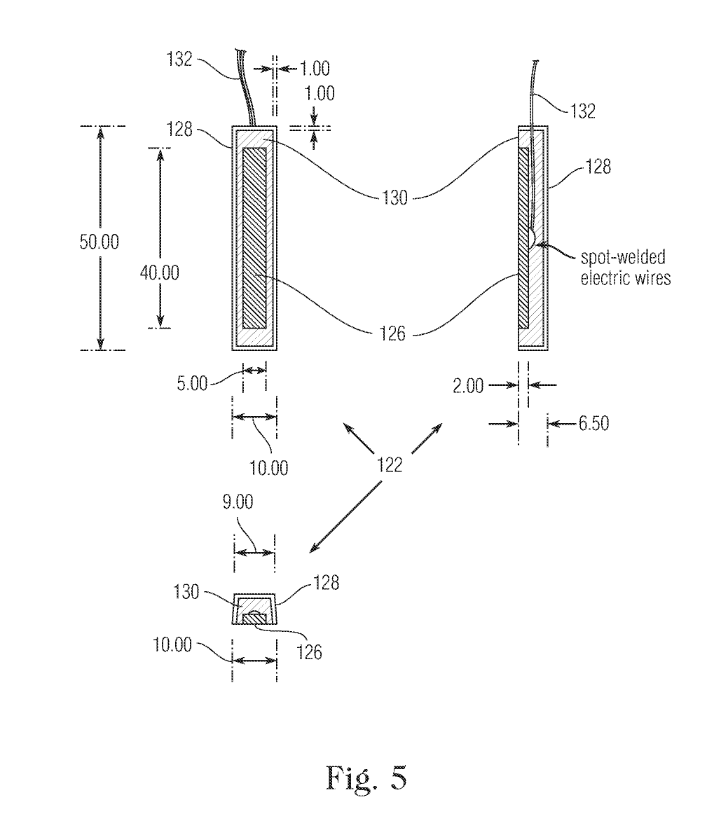

Referring to FIG. 5, the electrical probe 122 can include a working electrode 126 that is bonded into an outer shell 128 using an adhesive 130. The working electrode can be a piece of material that is being tested under the corrosion environment (e.g., low carbon steel). The outer shell 128 can be made from a non-reactive material (e.g., PEEK). The adhesive 130 can be, for example, a two-part adhesive that is suitable for the corrosive environment. A lead wire 132 can be attached to the back surface (surface not exposed to the test environment) of the working electrode 126. The lead wire 132 can include a PEEK coating as insulation. The wire 132 can be spot welded to the back surface of the electrode 126 and extend through a hole provided in the outer shell 128. Accordingly, at least one electrical probe 122 can be provided per insert, which can be used to measure corrosion using electrical signals at each of the phases in the multiphase environment.

In order to facilitate electrochemical corrosion measurement, a reference electrode 134 and a counter electrode 136 are provided as shown in FIG. 1, for example, and, in certain embodiments, can further include a pH electrode 135. The reference electrode 134 can be a point-electrode that has a stable potential regardless of the test environment. The reference electrode 134 can be a double junction silver/silver chloride electrode (e.g., Ag/AgCl in saturated KCl) housed in inert sleeves (e.g., Hastelloy C276 or PEEK sleeves), for example. The tip of the reference electrode 134 can be positioned in close proximity to the surface of the working electrodes 126. However, the position of the reference electrode 134 should not be so close as to impair the physical or chemical processes taking place at the surface of the working electrode as a result of the working electrode being exposed to the test environment. The counter electrode 136 is electrically conductive and also inert to the test environment. The counter electrode 136 can have a larger surface area than the working electrode 126 and the geometry of the counter electrode 136 can be such that it develops a similar potential difference at any point across from the surface of the working electrode. The counter electrode 136 can be a platinum gauze/mesh or graphite rods (as shown in FIG. 1), for example. The electrical leads connected to the reference electrode 134 and counter electrode 136 (in addition to the electrical lead connected to the working electrode 126) can be isolated from the test environment using a feed tube 138. The feed tube 138 can extend through a top of the autoclave outer vessel 102. The head of the autoclave vessel can include a feed tube fitting that is sized and shaped to allow the feed tube 138 to pass through. The lead wires can pass through the feed tube 138 so that electrical signals can be received and measured outside of the vessel. The feed tube 138 can be sized and shaped to receive a number of lead wires corresponding to the number of electrodes (e.g., three lead wires for three working electrodes, one for the reference electrode and one for the counter electrode). The feed tube 138 can be a Hastelloy C276 tube with drilled Teflon rod placed inside to seal and isolate the test environment, for example.

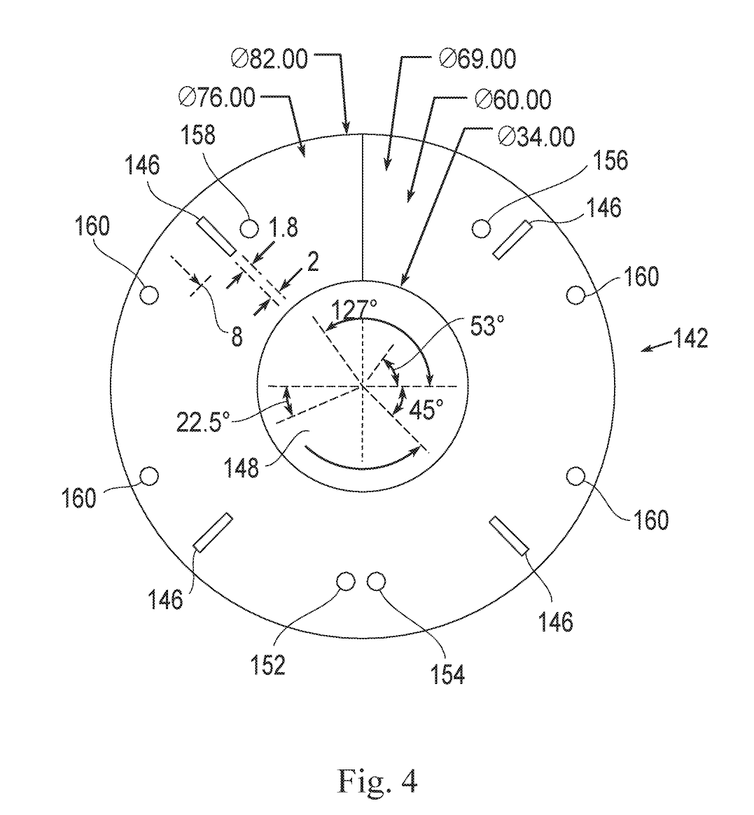

As discussed above, as shown in FIG. 1, the system can include three insert coupon holders 106, 108, and 110 disposed vertically on top of each other wherein each insert is exposed to a different phase of the test fluid, for example, an aqueous phase, an aqueous/hydrocarbon interface phase, and a gaseous phase. In order to help maintain stratification between the various phases within the test vessel, baffles 140 and separator plates 142 are provided, as shown in FIGS. 1, 2, and 4. Baffles 140 are supported by grooves 144 (e.g., dovetail shaped) in the inner surface of the inserts 106, 108, and 110 and extend toward the center of the interior of the inserts. By extending into the fluid test environment, the baffles 140 help to prevent vortex formation. Separator plates 142 are disposed between each of the inserts and on top of the upper most insert. The separator plates 142 include slots 146 that are also sized and shaped to receive and support the baffles. The separator plates 142 define a boundary between the inserts and further help to reduce vortex formation. Vortex formation can introduce unwanted turbulence into the system that can cause the stratification between the different phases of the test fluid to degrade, which can interfere with proper test results since defined phases are not maintained for each of the test coupons (e.g., unwanted hybrid environmental conditions can occur). The separator plates 142 can be disc shaped and include a central opening 148 that can accommodate a stirring rotor 150, as discussed in more detail below. The baffles 140 and separator plates 142 can be made from a corrosion-resistant material (e.g., PEEK). The separator plates 142 can include holes 152 and 154 that are sized and shaped to receive the counter electrode and reference electrode, respectively, and to position the electrodes within the system. The separator plates 142 can further include a hole 156 for passing through a temperature measurement probe (e.g., thermocouple) and a hole 158 sized and shaped to receive a gas purging tube (e.g., Hastelloy C276 dip tube). The separator plates 142 and inserts 106, 108, and 110 can further include bolt holes 160 that allow the three separator plates and three inserts to be bolted together with long bolts so that the plates and inserts can be inserted and removed as a unit. The bolts can be Hastelloy C276, for example. The unit can include a lifting device for easy handling.

A stirring rotor 150 can extend centrally through the three separator plates 142 and inserts 106, 108, and 110 to provide controlled stirring of the test fluid. A gate anchor impeller 162 can be attached at a lower end of the rotor 150 to provide controlled stirring of the aqueous phase 12 of the test fluid at the lower insert. A turbine impeller 164 can be attached at a mid-portion of the stirring rotor 150 to provide controlled stirring of the aqueous/hydrocarbon interface phase 14 of the test fluid at the middle insert. The turbine impeller 164 can be a 6-flat-blade disc turbine, for example. An impeller is not required to provide stirring at the upper portion of the stirring rotor 150 at the gaseous phase 16 of the test fluid. Rotating the stirring rotor 150 provides for controlled stirring of the test fluid so that test fluid moves across the surface of the coupons and electrical test probes, while baffles 140 and separator plates 142 prevent unwanted vortex that can disturb phase stratification of the fluid. A wobble preventer pin 166 can be disposed at a distal end of the stirring rotor 150 to prevent wobble of the stirring rotor 150 during rotation.

As one general example of a use of the test system described herein, coupons and working electrodes are loaded into the respective grooves of the inserts. Baffles of the construction described above are inserted into respective insert grooves and separator plates are disposed between adjacent inserts and a further separator plate is disposed on top of the upper most insert. The inserts and separator plates are bolted together. The inserts, separator plates, reference electrode, counter electrode, and stirring rotor are inserted into an interior of the outer vessel. The test fluid can then be added to the vessel and a head (e.g., cover) can be attached to the vessel to close the vessel. Electrode electrical lead wires (working, reference, and counter electrodes) extend through the head to an outside of the vessel. The volume, temperature and pressure of the test fluids inside the vessel are adjusted to achieve a multiphase condition (aqueous, aqueous/hydrocarbon interface, and gaseous phase) that occurs in a stratified condition such that the lower insert, middle inset, and upper insert, including their respective coupons/working electrodes, are each exposed to a different phase condition of the test fluid (i.e., aqueous, aqueous/hydrocarbon interface, and gaseous phase, respectively). The stirring rotor can be rotated to achieve controlled stirring of the fluid while baffles and separator plates help prevent vortex formation. Electrochemical corrosion rates can be measured by monitoring electrical signals from the working electrode using the reference and counter electrodes, which can be done during the test. After the test phase is complete, the inserts are removed from the vessel and the coupons are removed from the inserts so that a post-test weight of the coupons can compared to a pre-test weight of the coupons to determine weight loss, which can be used to determine corrosion rate.

Accordingly, a system and method is provided for high-through put corrosion testing in multi-phase environment using two different testing methods (weight-loss and electrochemical) as a result of a single test. Being able to test multi-phase environments greatly increases the number of environments that can be tested without the time and expense of multiple test procedures. Moreover, the ability to measure corrosion rates using two different methods simultaneously during the same test greatly increases accuracy while further eliminating the time and cost of having to conduct multiple, separate tests. A further advantage of performing two different corrosion measurement methods during same test environment further increases accuracy because performing two different, separate tests can introduce differences in results that are a result of difference in the test itself (volume, temperature, pressure, time, equipment setup variables, etc.), which are eliminated when these two different methods are employed as part of the same test procedure. Moreover, a transparent vessel and windows in the inserts provides for visual inspection during the testing, which can lead to insights about the corrosion test that may vary throughout the duration of the test, which may not be readily observable by conducting pre- and post-test inspections.

Notably, the figures and examples above are not meant to limit the scope of the present application to a single implementation, as other implementations are possible by way of interchange of some or all of the described or illustrated elements. Moreover, where certain elements of the present application can be partially or fully implemented using known components, only those portions of such known components that are necessary for an understanding of the present application are described, and detailed descriptions of other portions of such known components are omitted so as not to obscure the application. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present application encompasses present and future known equivalents to the known components referred to herein by way of illustration.

The foregoing description of the specific implementations will so fully reveal the general nature of the application that others can, by applying knowledge within the skill of the relevant art(s) (including the contents of the documents cited and incorporated by reference herein), readily modify and/or adapt for various applications such specific implementations, without undue experimentation, without departing from the general concept of the present application. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown of drawings are shown accordingly to one example and other dimensions can be used without departing from the invention.

While various implementations of the present application have been described above, it should be understood that they have been presented by way of example, and not limitation. It would be apparent to one skilled in the relevant art(s) that various changes in form and detail could be made therein without departing from the spirit and scope of the application. Thus, the present application should not be limited by any of the above-described example implementations.

What is claimed:

1. A multi-phase testing system for testing corrosive environments by providing a test fluid mixture that is at a different phase at different locations within the system in surrounding relation to a plurality of test coupons, wherein corrosion rates can be determined via weight-loss means and electrochemical means on the plurality of test coupons, comprising:
a housing defining an inner chamber;
a plurality of inserts disposed vertically within the housing, each insert defining an interior area and an interior surface, wherein at least one test coupon among the plurality of test coupons is disposed at an inner surface of each of the plurality of inserts;
a plurality of electrical probes, wherein at least one electrical probe is disposed at an inner surface of each of the plurality of inserts, and each electrical probe having an electrical lead wire electrically connected to the electrical probe and extending outside the housing for reading electrical signals through the wire; and
a plurality of separator plates, wherein one of the plurality of separator plates is disposed between each adjacent insert;
wherein the separator plates are configured to maintain a separation between each of the phases of the multi-phase test fluid disposed within the housing so that each of the test coupons and electrical probes in each of the inserts is exposed to a different phase of the test fluid;
wherein corrosion is measured by measuring the amount of weight-loss of each of the test coupons and by measuring the electrical signals from each electrical probe.

2. The test system according to claim 1, wherein each insert includes a plurality of grooves disposed about the inner surface of the inserts, wherein the grooves are sized and shaped to receive test coupons and electrical probes, respectively.

3. The test system according to claim 2, wherein the grooves have a dovetail shape.

4. The test system according to claim 1, wherein each insert includes at least one window that permits viewing of the interior area of the insert.

5. The test system according to claim 1, further comprising a reference electrode and a counter electrode disposed within the housing that provide a reference electrical signal and a counter electrode electrical signal, wherein the reference electrical signal and the counter electrode electrical signal are capable of being used, in combination with the electrical signal from the electrical probes, to measure corrosion using electrical signals.

6. The test system according to claim 1, further comprising a stirring rod for stirring the test fluid disposed within the housing.

7. The test system according to claim 1, further comprising a plurality of baffles supported by the inserts.

8. A method for performing multi-phase testing of corrosive environments via a weight-loss method and an electrochemical method by providing a test fluid mixture that is at a different phase at different locations within the system, comprising the steps of:
providing a test system, the test system including:
a housing defining an inner chamber;
a plurality of inserts disposed vertically within the housing, each insert defining an interior area and an interior surface;
a plurality of test coupons, wherein at least one test coupon is disposed at an inner surface of each of the plurality of inserts;
a plurality of electrical probes, wherein at least one electrical probe is disposed at an inner surface of each of the plurality of inserts, and each electrical probe having an electrical lead wire electrically connect to the electrical probe and extending outside the housing for reading electrical signals through the wire; and
a plurality of separator plates, wherein one of the plurality of separator plates is disposed between each adjacent insert;
wherein the separator plates are configured to maintain a separation between each of the phases of the multi-phase test fluid disposed within the housing so that each of the test coupons and electrical probes in each of the inserts is exposed to a different phase of the test fluid;
providing the test fluid in the inner chamber of the housing;
maintaining the temperature and pressure within the housing such that the test fluid exists as a vertically stratified, multiphase fluid;
determining an electrochemical corrosion rate by measuring the electrical signals from the electrical probes; and
determining a weight-loss corrosion rate by comparing a pre-test and a post-test weight of the coupons,
wherein the determined corrosion rates from the test coupons and electrical probes from each respective, vertically arranged insert corresponds to the corrosion rate for a corresponding, respective phase of the vertically stratified, multiphase fluid.
